(19) United States
(12) Patent Application Publication
(10) Pub. No.: US 2010/0246070 A1
(43) Pub. Date: Sep. 30, 2010

(54) HEAD STACK ASSEMBLY AND HARD DISK DRIVE HAVING THE SAME

(75) Inventors: Jung Moo SON, Gunpo-si (KR); Byung-Soo Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/749,706

(22) Filed: Mar. 30, 2010

(30) Foreign Application Priority Data
Mar. 30, 2009 (KR) 2009-0027049

(51) Int. Cl. G11B 5/55

(52) U.S. Cl. 360/265.1; G9B/5.182

(57) ABSTRACT

A hard disk drive includes a head stack assembly including a read/write head mounted thereon and an actuator arm pivoting over a disk around a pivot shaft installed on a base, a pivot shaft holder rotatably supporting the pivot shaft and to which the actuator arm is coupled, and a bobbin provided at the opposite side of the actuator arm with respect to the pivot shaft holder and having a voice coil motor coil installed on at least one surface thereof, a crash stop coupled to the base and restricting displacement of the actuator arm, and a contact area reduction portion provided on at least one of the bobbin and the crash stop and including at least one non-contact section, in which the bobbin and the crash stop do not contact each other, in a contact section of the bobbin and the crash stop, when the bobbin and crash stop contact each other, to reduce the contact area between the bobbin and the crash stop.

### CROSS-REFERENCE TO RELATED APPLICATIONS

This application claims priority under Korean Patent Application No. 10-2009-0027049, filed on Mar. 30, 2009, in the Korean Intellectual Property Office, the disclosure of which is incorporated herein in its entirety by reference.

### BACKGROUND

1. Field of the Invention

The inventive concept relates to an auxiliary memory device of a computer system, and more particularly, to a hard disk drive capable of reducing a stiction phenomenon of a crash stop and a bobbin.

2. Description of the Related Art

HDDs are data storage devices capable of recording data on a disk or reproducing data stored on the disk using a read/write head. The HDD is widely used as an auxiliary memory device for computer systems because of its fast access time to a large amount of data.

With the recent increase in TPI (tracks per inch) and BPI (bits per inch), the HDD is implemented to have a high capacity and extended application fields. Accordingly, compact HDDs which may be used for portable electronic products such as laptops, personal digital assistants (PDAs), and mobile phones have been actively developed. An HDD having a diameter of 2.5 inches has been developed and applied to laptops. Also, a compact HDD having a relatively smaller diameter, for example, 0.8 inches, or the equivalent to that of a coin, has been developed for mobile phones or MP3 players.

In general, the HDD includes a disk pack, a printed circuit board assembly (PCBA), a base, a cover, a head stack assembly (HSA) including an actuator arm and a bobbin, a voice coil motor (VCM), a ramp, a latch device, and a crash stop to restrict the displacement of the actuator arm, in particular, an outer disk crack stop (ODCS) to restrict the clockwise displacement of the actuator arm.

However, in the HDD, when a rotary shock is applied, in order to reduce a shock delivered to the HSA and the latch device, the ODCS is manufactured of a rubber material having a high shock-absorption characteristic, such as nitrile butadiene rubber (NBR). When the ODCS contacts the bobbin, although no problem occurs in the room temperature, friction is generated between the ODCS and the bobbin in a high temperature environment, such as in a burn-in process or a high temperature reliability test, so that a static friction (“stiction”) phenomenon occurs in which the ODCS and the bobbin are stuck together. Thus, due to the stiction phenomenon, a variety of defects may occur and thus yield and productivity decrease.

To address the above issue, a method of changing the material of the ODCS has been considered. However, the method does not work well because of a technical contradiction that the ODCS needs to be soft to absorb a shock well but hard to effectively prevent the stiction phenomenon. Thus, there is a demand for a method to reduce the stiction phenomenon while maintaining a shock absorption function

### SUMMARY

The inventive concept provides an HDD which can reduce the friction between the crash stop and the bobbin to reduce the stiction phenomenon, thereby reducing generation of defects and improving yield and productivity.

Additional features and utilities of the present general inventive concept will be set forth in part in the description which follows and, in part, will be obvious from the description, or may be learned by practice of the general inventive concept.

Features and/or utilities of the present general inventive concept may be realized by a hard disk drive including a head stack assembly including a read/write head mounted thereon and an actuator arm pivoting over a disk around a pivot shaft installed on a base, a pivot shaft holder rotatably supporting the pivot shaft and to which the actuator arm is coupled, and a bobbin provided at the opposite side of the actuator arm with respect to the pivot shaft holder and having a voice coil motor coil installed on at least one surface thereof, a crash stop coupled to the base and restricting displacement of the actuator arm, and a contact area reduction portion provided on at least one of the bobbin and the crash stop and including at least one non-contact section, in which the bobbin and the crash stop do not contact each other, in a contact section of the bobbin and the crash stop, when the bobbin and crash stop contact each other, to reduce the contact area between the bobbin and the crash stop.

The contact area reduction portion may include a plurality of concaves or recesses inwardly formed in one surface of the bobbin facing the crash stop.

An imaginary surface connecting a plurality of protruding surfaces generated by the plurality of concaves may form substantially the same plane with an outer surface of the bobbin, and both sides of each of the plurality of protruding surfaces may be round-processed.

The contact area reduction portion may include a plurality of concaves or recesses provided in a side surface of the bobbin facing the crash stop to be separated from each other and protruding outwardly from a surface of the bobbin.

The contact area reduction portion may have a thickness thinner than that of the bobbin.

The contact area reduction portion may be integrally formed on the bobbin.

The crash stop may include a housing shaft coupled to the base and a buffer member arranged outside the housing shaft and contacting the bobbin.

The contact area reduction portion may include a plurality of concaves or recesses inwardly formed in a side surface of the buffer member facing the bobbin.

A buffer space to absorb a shock may be provided between the housing shaft and the buffer member.

The crash stop may be an outer disk crash stop.

Features and/or utilities of the present general inventive concept may also be realized by a hard disk drive including a head stack assembly including a bobbin and an arm rotatable around a shaft and a crash stop to restrict movement of the bobbin. One of the bobbin and the crash stop may include a contact area reduction portion including a plurality of recesses to reduce a surface area of the bobbin that contacts the crash stop.

The contact area reduction portion may have a thickness less than a thickness of the bobbin.

A depth of each of the plurality of recesses may be less than a depth of the contact area reduction portion.

The contact area reduction portion may be located on the bobbin.

The plurality of recesses may define a plurality of protrusions, and an outer surface of each of the plurality of protrusions may be co-planar with an outer surface of the bobbin.

An outer surface of each of the plurality of protrusions may extend past an outer surface of the bobbin.

The contact area reduction portion may be integral with the bobbin.

The contact area reduction portion may be formed separately from and may be mounted to the bobbin.

The plurality of recesses may span from a first edge of the bobbin to a second edge of the bobbin.

The plurality of recesses may extend perpendicular to a side edge of the bobbin, and the plurality of recesses may extend from the outer side edge toward a center portion of the bobbin.

The contact area reduction portion may be located on the crash stop.

The plurality of recesses defines a plurality of protrusions, and an outer surface of each of the plurality of protrusions may be co-planar with an outer surface of the crash stop.

An outer surface of each of the plurality of protrusions may extend past an outer surface of the crash stop.

The contact area reduction portion may be integral with the crash stop.

The contact area reduction portion may be formed separately from and mounted to the crash stop.

Features and/or utilities of the present general inventive concept may also be realized by a head stack assembly including an actuator arm including a shaft holder to mount to a shaft to rotate the actuator arm around the shaft, a head at an end of the actuator arm to read data from and write data to a disk, and a bobbin at an end of the actuator arm opposite the head to drive the actuator arm to rotate around the shaft. The bobbin may include a contact area reduction portion including a plurality of recesses to reduce a surface area of the bobbin that contacts a crash stop to restrict a rotation of the bobbin in a first rotation direction.

The bobbin may include a voice coil motor coil to receive a magnetic force to drive the rotation of the actuator arm.

The bobbin may include a hook to connect with a latch to prevent movement of the bobbin in a second rotation direction opposite the first rotation direction.

Features and/or utilities of the present general inventive concept may also be realized by a hard disk drive including a hard disk, a head stack assembly including a bobbin and an arm rotatable around a shaft to move the arm across the hard disk, the arm including a head to read data from and write data to the hard disk, and a crash stop to restrict rotation of the bobbin in a first rotation direction. One of the bobbin and the crash stop may include a contact area reduction portion including a plurality of recesses to reduce a surface area of the bobbin that contacts the crash stop.

The hard disk drive may include a base, and the shaft and the crash stop may be mounted to the base.

The hard disk drive may further include voice coil magnets fixed with respect to the base, and the bobbin may include a voice coil motor coil to receive a magnetic force from the voice coil magnets to drive a rotation of the actuator arm.

The hard disk drive may further include a latch mounted to the base, and the bobbin may include a hook to connect with the latch to prevent movement of the bobbin in a second rotation direction opposite the first rotation direction.

The latch may include a first hook and second hook, the first hook located farther down the latch in the second rotation direction than the second hook, such that the hook of the bobbin connects with the second hook at a first rotation angle and with the first hook at a second angle greater than the first rotation angle in the second rotation direction.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a partially exploded perspective view of an HDD according an exemplary embodiment of the present general inventive concept;

FIG. 2 is a plan view of the HDD of FIG. 1 without the cover;

FIG. 3 illustrates that the bobbin contacts the crash stop in the HDD of FIG. 1;

FIG. 4 is an enlarged plan view of a portion “A” of FIG. 3;

FIG. 5 is a perspective view of the HSA of the HDD of FIG. 1;

FIG. 6A is an enlarged perspective view illustrating a major portion of FIG. 5;

FIGS. 6B and 6C illustrate the contact area reduction portion from different perspectives;

FIG. 7 is an enlarged perspective view illustrating the contact area reduction portion provided in the bobbin of an HDD according to another exemplary embodiment of the present general inventive concept;

FIG. 8A is an enlarged plan view illustrating the contact area reduction portion provided in the crash stop of an HDD according to another exemplary embodiment of the present general inventive concept;

FIG. 8B illustrates an enlarged plan view of the contact area reduction portion according to another embodiment of the present general inventive concept; and

FIGS. 9A and 9B illustrate embodiments of contact area reduction portions according to the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

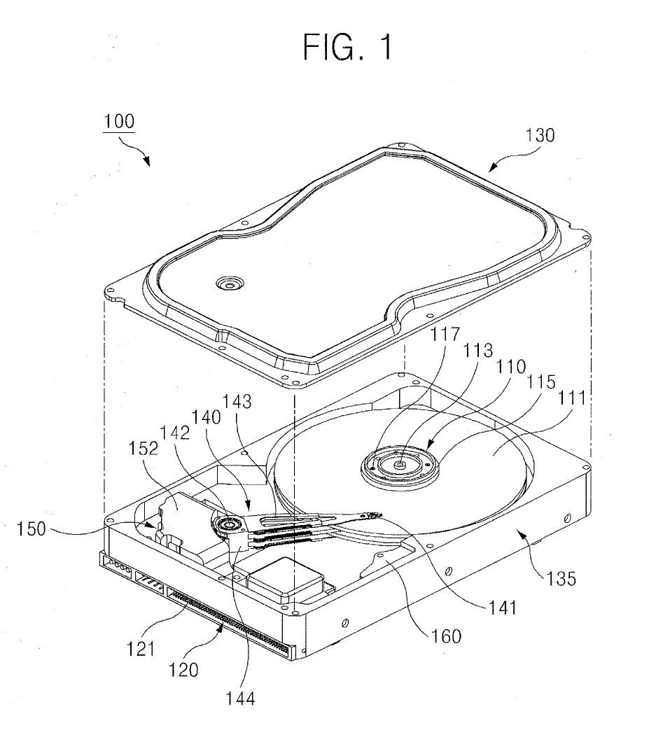

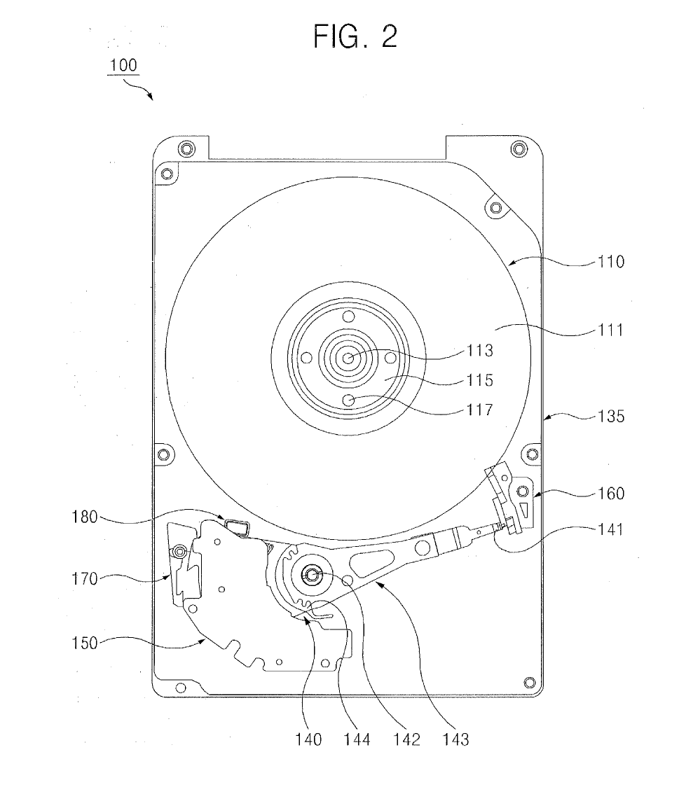

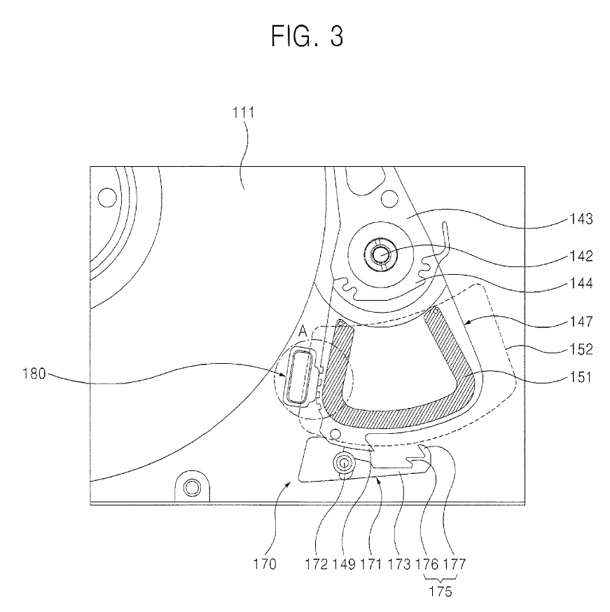

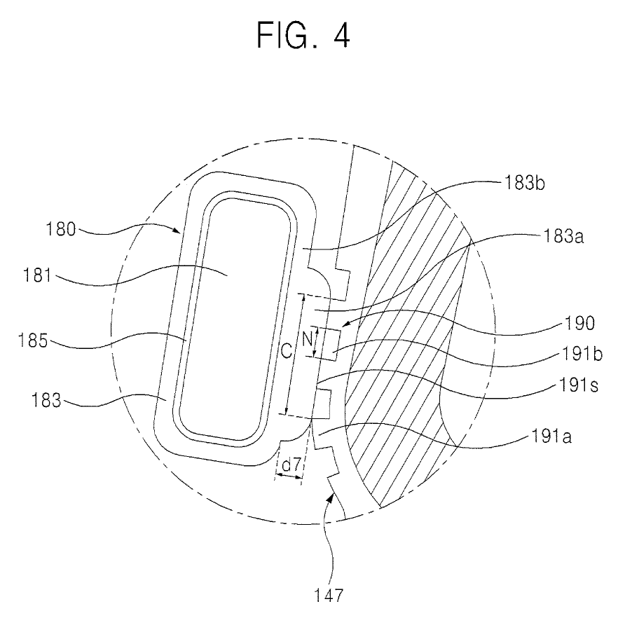

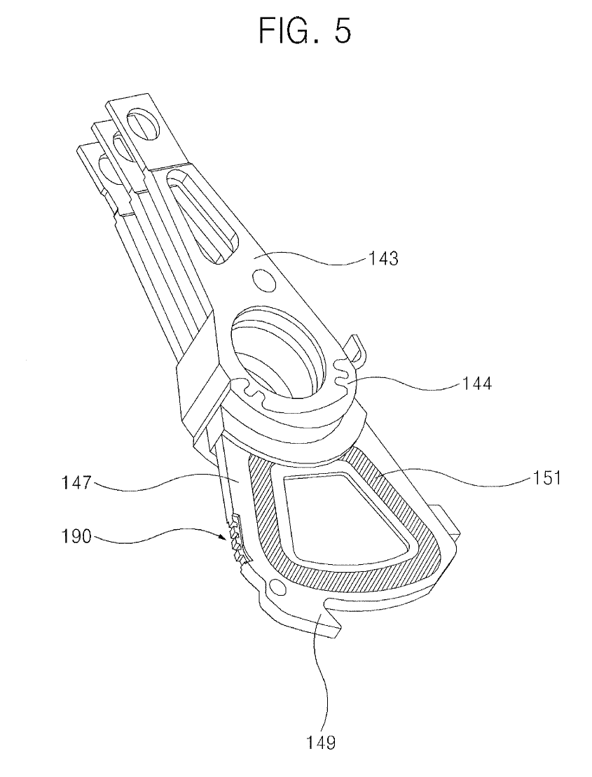

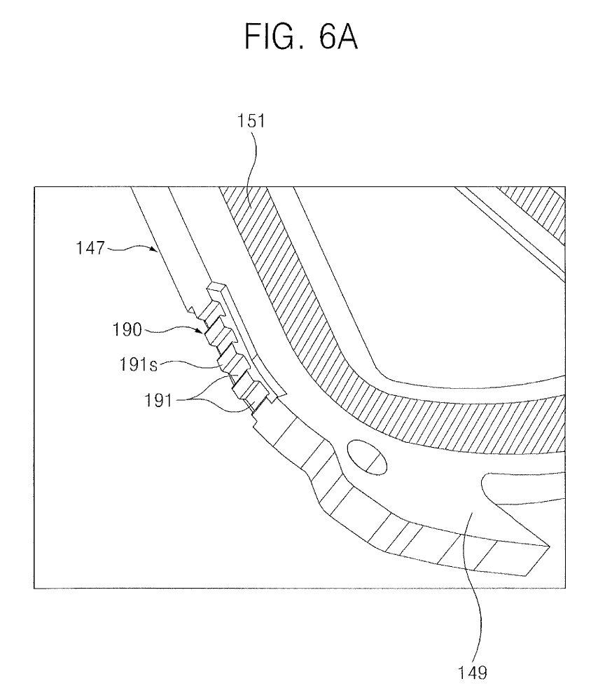

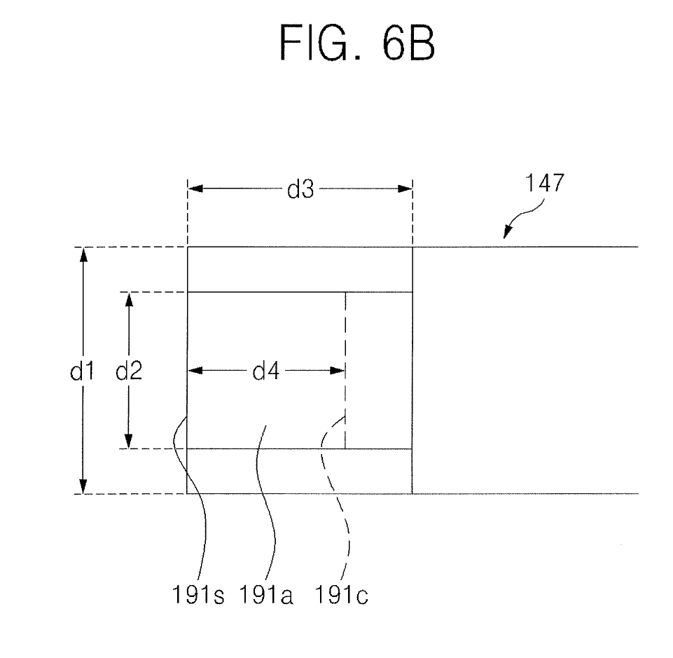

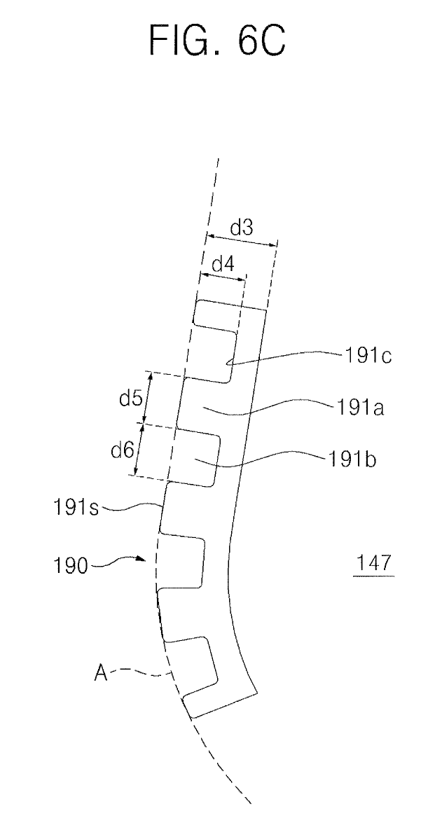

FIG. 1 is a partially exploded perspective view of an HDD according an exemplary embodiment of the present inventive concept. FIG. 2 is a plan view of the HDD of FIG. 1 without the cover. FIG. 3 illustrates that the bobbin contacts the crash stop in the HDD of FIG. 1. FIG. 4 is an enlarged plan view of a portion “A” of FIG. 3. FIG. 5 is a perspective view of the HSA of the HDD of FIG. 1. FIG. 6A is an enlarged perspective view illustrating a major portion of FIG. 5.

Referring to FIGS. 1-6C, a hard disk drive (HDD) 100 according to an exemplary embodiment of the present inventive concept includes a disk pack 110 having a disk 111, a printed circuit board assembly (PCBA) 120, a base 135, a cover 130, a head stack assembly (HSA) 140 having an actuator arm 143 on which a read/write head 141 is mounted and a bobbin 147 on which a voice coil motor (VCM) coil 151 is installed, a VCM 150 to pivot the HSA 140, a ramp 160 on which the read/write head 141 of the HSA 140 is parked in a non-operation mode, a latch device 170 to prevent the read/write head 141 from moving toward the disk 111 by maintaining a hook coupling state to the HSA 140, and a crash stop 180 to restrict the displacement of the actuator arm 143.

An outer disk crash stop (ODCS) and an inner disk crash stop (IDCS) may be used as a buffer unit to restrict the displacement of the actuator arm 143 to prevent the read/write head 141 from moving to a position where servo information of the disk 111 is not written, or for a variety of reasons. In the present exemplary embodiment, the crash stop 180 is the ODCS that contacts the bobbin 147 when the read/write head 141 is parked on the ramp 160.

The disk pack 110 includes the disk 111, a shaft 113 that acts as a rotational shaft of the disk 111, a spindle motor hub (not shown) provided at the radially outside of the shaft 113 and supporting the disk 111, a clamp 115 coupled to the upper portion of the spindle motor hub, and a clamp screw 117 pressing the clamp 115 to fix the disk 111 to the spindle motor hub.

The PCBA 120 includes a plate shaped printed circuit board (PCB; not shown) and a PCB connector 121 provided at one side of the PCB. The PCB includes a plurality of chips and circuits (not shown) to control the disk 111 and the read/write head 141 and may communicate signals with an external apparatus via the PCB connector 121.

The base 135 forms a frame, and the disk pack 110, the HSA 140, and the PCBA 120 are assembled on the base 135. Also, the ramp 160, on which the read/write head 141 is parked when power is cut off, is installed on the base 135. The cover 130 protects the disk 111 and the HSA 140 by shielding the upper surface of the base 135.

The HSA 140 is a carrier to write data to the disk 111 or read the written data and includes the read/write head 141 to write data to the disk 111 or read the written data, the actuator arm 143 pivoting around a pivot shaft 142 above the disk 111 so that the read/write head 141 may access data on the disk 111, a suspension (not shown) coupled to the end portion of the actuator arm 143, a pivot shaft holder 144 rotatably supporting the pivot shaft 142 and supporting the actuator arm 143 that is coupled thereto, and the bobbin 147 provided at the opposite side of the actuator arm 143 with respect to the pivot shaft holder 144 and arranged between VCM magnets 152 of the VCM 150.

The read/write head 141 reads or writes information with respect to the disk 111 that is rotating, respectively, by sensing a magnetic field formed on the surface of the disk 111 or magnetizing the surface of the disk 111. The read/write head 141 includes a read head for sensing the magnetic field of the disk 111 and a write head for magnetizing the disk 111.

The VCM 150 is a type of a driving motor that pivots the actuator arm 143 of the HSA 140 to move the read/write head 141 to a desired position of the disk 111 by utilizing the Fleming's left hand rule, that is, when current is applied to a conductive body existing in a magnetic field, an electromagnetic force is generated. A force is applied to the bobbin 147 so as to pivot by applying current to the VCM coil 151 located between the VCM magnets 152. Accordingly, as the actuator arm 143 pivots in a predetermined direction, the read/write head 141 mounted at the end portion of the actuator arm 143 may move in a radial direction of the disk 111 that is rotating and simultaneously search and access a desired track (not shown). Thus, the data may be recorded on the disk 111 or the data recorded on the disk 111 may be reproduced.

According to the above-described structure, when power is applied to the HDD 100, the disk 111 starts to rotate. Then, the read/write head 141 coupled to the leading end portion of the actuator arm 143 is raised to a predetermined height by a lift force generated during the rotation of the disk 111.

In contrast, when the supply of power to the HDD 100 is discontinued, the rotation of the disk 111 is stopped and the actuator arm 143 is rotated around the pivot shaft 142 and parked on the ramp 160. When an external shock is applied to the HDD 100, an end tab (not shown) formed at the leading end portion of the actuator arm 143 may be separated from the ramp 160. When being separated, the actuator arm 143 may pivot toward the disk 111 so that the read/write head 141 may be moved to a data area of the disk 111. However, since the disk 111 is stopped, the read/write head 141 may not be able to raise the read/write head 141 to a predetermined height. Thus, the read/write head 141 may interface with the disk 111 so that the read/write head 141 or the disk 111 may be damaged.

Accordingly, the HDD 100 further includes the latch device 170 to prevent the read/write head 141 coupled to the leading end portion of the actuator arm 143 from moving toward the disk 111 by latching the actuator arm 143 when the power is not applied, and the crash stop 180 to restrict the displacement of the actuator arm 143, which is contacted by the bobbin 147 when the read/write head 141 is parked on the ramp 160. In the present exemplary embodiment, the crash stop 180 is the ODCS.

First, the latch device 170 automatically unlatches the actuator arm 143 when current is applied to the VCM coil 151 by using the electromagnetic force generated by the VCM 150 to move the read/write head 141 over the disk 111. Also, when current is not applied to the VCM coil 151, the latch device 170 firmly latches the actuator arm 143.

The latch device 170 according to the present exemplary embodiment includes, as illustrated in FIGS. 2 and 3, a latch lever 171 rotatably installed on the base 135 to restrict the pivoting of the actuator arm 143, and a hook portion 149 provided on the bobbin 147 of the actuator arm 143 to be hook coupled to, or released from, the latch lever 171.

The latch lever 171 is coupled to the base 135 to be capable of pivoting close to the VCM magnets 152 and includes a pivot center portion 172, a latch arm 173 coupled to the pivot center portion 172, and a catch portion 175 provided at the leading end portion of the latch arm 173 to catch the hook portion 149 of the bobbin 147 when the actuator arm 143 rotates counterclockwise.

The latch arm 173 pivots around the center of the pivot center portion 172 so that the hook portion 149 of the bobbin 147 may be latched by or unlatched from the catch portion 175. In other words, when an external rotary shock in a clockwise or counterclockwise direction is applied to the HDD 100, an inertia force is generated in the latch arm 173 to move in the opposite direction to the direction of the external force. Due to the inertial force, the hook portion 149 of the bobbin 147 may be latched by the catch portion 175 protruding from the leading end portion of the latch arm 173. Accordingly, the actuator arm 143 may be prevented from freely pivoting.

As illustrated in FIG. 3, the catch portion 175 includes a first hook 176 protruding from the latch arm 173 to connect with the hook portion 149 of the bobbin 147 and a second hook 177 protruding from the latch arm 173 close to the first hook 176 to connect with the hook portion 149 when the hook portion 149 is not hook coupled to the first hook 176.

When the catch portion 175 is configured as described above, even when the first hook 176 fails to connect with the hook portion 149 of the bobbin 147 to stop the actuator arm 143, the second hook 176 may still catch the hook portion 149 to stop the actuator arm 143.

In the present exemplary embodiment, the crash stop 180 may be an ODCS to restrict the clockwise movement angle of the actuator arm 143 and to improve the rotary shock that may be generated in various environments. The crash stop 180 may be formed of a rubber material such as nitrile butadiene rubber (NBR) to absorb a shock and to reduce the shock delivered to the HSA 140 and the latch device 170 when a rotary shock is applied to the hard disk drive 100. However, although rubber functions well at room temperature, in a high temperature state such as in a burn-in process or a high temperature reliability test, friction may be generated between the crash stop 180 and the bobbin 147, and the crash stop 180 and the bobbin 147 may stick together.

To reduce a stiction phenomenon while maintaining the shock absorbing function without changing the material, the HDD 100 of the present exemplary embodiment, as illustrated in FIGS. 3 and 4, further includes a contact area reduction portion 190 on a portion of the bobbin 147 that contacts the crash stop 180 to reduce the contact area between the bobbin 147 and the crash stop 180 The contact area reduction portion 190 includes a contact section C to generally include one or more surfaces to contact the crash stop 180. The contact section C includes one or more non-contact sections N in which the bobbin 147 and the crash stop 180 do not contact each other. In other words, the contact section C includes contacting projections 191a and non-contact recesses, cavities, or concaves 191b between the contacting projections 191a.

Since the generation of the stiction phenomenon is proportional to the contact area between the bobbin 147 and the crash stop 180 in a conventional HDD (not shown), in the HDD 100 of the present exemplary embodiment, the contact area reduction portion 190 reduces the contact area between the bobbin 147 and the crash stop 180 to prevent the stiction phenomenon from occurring.

The contact area reduction portion 190 of the present exemplary embodiment, as illustrated in FIGS. 3-6A, may be include a plurality of concaves 191b inwardly formed on the outer surface of the bobbin 147 facing the crash stop 180.

Also, in the present exemplary embodiment, as illustrated in FIG. 6A, the contact area reduction portion 190 including the concaves 191b has a thickness thinner than the thickness of the bobbin 147. Accordingly, when the crash stop 180 contacts the contact area reduction portion 190 of the bobbin 147, since only a protruding surface 191s having a thickness thinner than that of the bobbin 147 contacts the crash stop 180, the contact area between the crash stop 180 and the bobbin 147 is further decreased compared to a conventional HDD. Since the contact area is reduced compared to a conventional HDD due to the reduced thickness of the contact area reduction portion 190 and the presence of the concaves 191b that reduce a surface area of the contact area reduction portion 190 that contacts the crash stop 180, the occurrence of defects due to the stiction phenomenon occurring between the crash stop 180 and the bobbin 147 in the high temperature burn-in process or the high temperature reliability test may be reduced.

Also, when an outer surface 191s of the protrusion portions 191a are located along a same plane as an outer edge of the bobbin 147, or in other words, when the protruding portions 191a are formed by forming concaves 191b in the contact area reduction portion 190, there is no need to adjust the installation positions of the bobbin 147 and the crash stop 180 due to the contact area reduction portion 190 to accommodate the contact area reduction portion 190.

Furthermore, both sides of the protruding surface 191s of the contact area reduction portion 190 may be round-processed, or rounded, as illustrated in FIG. 6A. In this case, a possible damage to the crash stop 180 due to repeated collisions between the crash stop 180 and the contact area reduction portion 190 of the bobbin 147 may be reduced.

The crash stop 180 of the present exemplary embodiment includes, as illustrated in FIGS. 3 and 4, a housing shaft 181 coupled to the base 135 and a buffer member 183 arranged outside the housing shaft 181 and directly contacting the bobbin 147 when the bobbin 147 contacts the crash stop 180. Also, a buffer space 185 is formed between the housing shaft 181 and the buffer member 183. Accordingly, when the contact area reduction portion 190 of the bobbin 147 collides against the buffer member 183 of the crash stop 180 due to the rotary shock, the shock is well absorbed so that the amount of shock may be reduced.

The housing shaft 181 may be fixedly coupled to the base 135. The buffer member 183 encompasses the housing shaft 181, as illustrated in FIG. 4. Although in the present exemplary embodiment the buffer member 183 is coupled to the housing shaft 181 by encompassing the entire outer circumference of housing shaft 181, the buffer member 183 may be formed only at a portion of the housing shaft 181 directly contacting the contact area reduction portion 190 of the bobbin 147, thus partially encompassing the housing shaft 181.

The buffer member 183 includes a portion 183a that directly contacts the contact area reduction portion 190 of the bobbin 147. The contacting portion 183a protrudes higher than the other portion 183b by a distance d7. Also, the buffer member 183 may be formed of an NBR material to reduced the amount of shock generated during the collision against the contact area reduction portion 190 of the bobbin 147. That is, when the contact area reduction portion 190 of the bobbin 147 collides against the buffer member 183, since the buffer member 183 formed of the NBR material performs a buffer function, the amount of shock delivered to the actuator arm 143 may be reduced. The NBR is synthetic rubber made of copolymerization of acrylonitrile and butadiene and exhibits an anti-abrasion characteristic.

FIGS. 6B and 6C illustrate the contact area reduction portion 190 from a side or width direction of the bobbin 147 and a top view of the bobbin, respectively. In FIG. 6B, the bobbin 147 has a width d1 and the contact area reduction portion 190 has a width d2 that is less than the width d1. In addition, the contact area reduction portion 190 has a depth d3 and the recesses have a depth d4 measured between an outer surface of a protrusion 191a and a recessed surface 191c. In FIG. 6C, each protrusion 191a has a width d5 and each recess 191b between each protrusion 191a has a width d6.

The thickness d2 of the contact area reduction portion 190 and the widths of the protrusions 191a and recesses 191b may be adjusted to result in a desired friction characteristic. For example, the thickness d2 of the contact area reduction portion 190 may be increased to increase a friction characteristic between the contact area reduction portion 190 and a crash stop 180 contacting the contact area reduction portion 190. Likewise, a width d6 of the recesses 191b may be decreased and a width d5 of the protrusions 191a may be increased to increase a friction characteristic with a crash stop 180 contacting the contact area reduction portion 190.

In addition, FIG. 6C illustrates a plane A defining a shape of an outer edge of the bobbin 147. When the contact area reduction portion 190 is formed by forming recesses 191b in the bobbin 147, the outer surfaces 191s may be located along the plane A defining the shape of the outer edge of the bobbin 147. Alternatively, the protrusions 191a may be formed to have outer surfaces 191s that extend beyond the plane A defining the shape of the outer edge of the bobbin 147.

According to the above-described structure, since the contact area between the crash stop 180 and the bobbin 147 is reduced by the contact area reduction portion 190 provided in the bobbin 147, the friction between the crash stop 180 and the bobbin 147 is relatively reduced in the burn-in process or the high temperature reliability test of the HDD 100 so that the stiction phenomenon may be reduced. Accordingly, the generation of a defect may be reduced and thus yield and productivity may be improved. Furthermore, while the stiction phenomenon is reduced, the buffer member 183 of the crash stop 180 is still manufactured of a soft material so that, during the collision between the crash stop 180 and the bobbin 147 due to the rotary shock, the function to absorb the shock may be absorbed.

An HDD according to another exemplary embodiment of the present inventive concept will be described with reference to the accompanying drawings. However, in the following description, the same descriptions on the constituent elements as those of the HDD according to the above-described exemplary embodiment will be omitted herein.

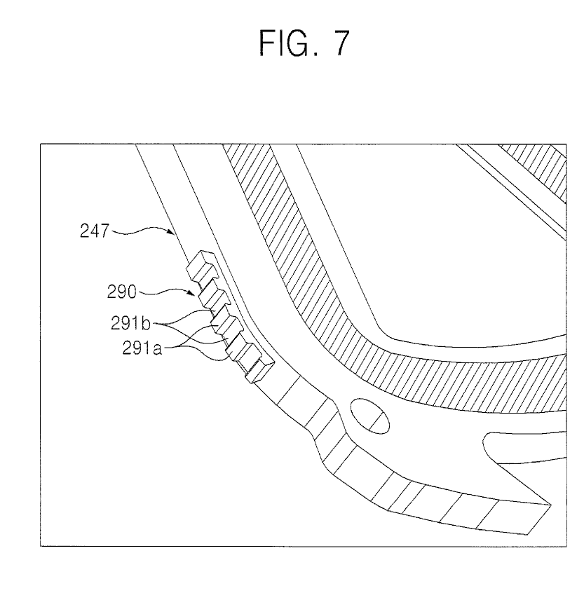

FIG. 7 is an enlarged perspective view illustrating the contact area reduction portion provided in the bobbin of an HDD according to another exemplary embodiment of the present general inventive concept. Referring to FIG. 7, a contact area reduction portion 290 according to the present exemplary embodiment includes a plurality of protrusions 291a protruding outwardly from the outer surface of a bobbin 247 and defining a plurality of recesses 291b. Unlike the contact area reduction portion 190 of FIG. 3, the contact area reduction portion 290 may be formed separately from the bobbin 247 and mounted to the bobbin 247 by an adhesive or welding, for example. The thickness of the protrusions 291a may be thinner than that of the bobbin 247, which further decreases the area contacting a crash stop (not shown).

According to the above-described structure, while the function to absorb a shock during the collision between the crash stop and the bobbin 247 is maintained, the stiction phenomenon of the crash stop and the bobbin 247 is reduced during the burn-in process or high temperature reliability test of the HDD so that the generation of a defect due to the stiction phenomenon may be reduced. Thus, yield and productivity may be improved.

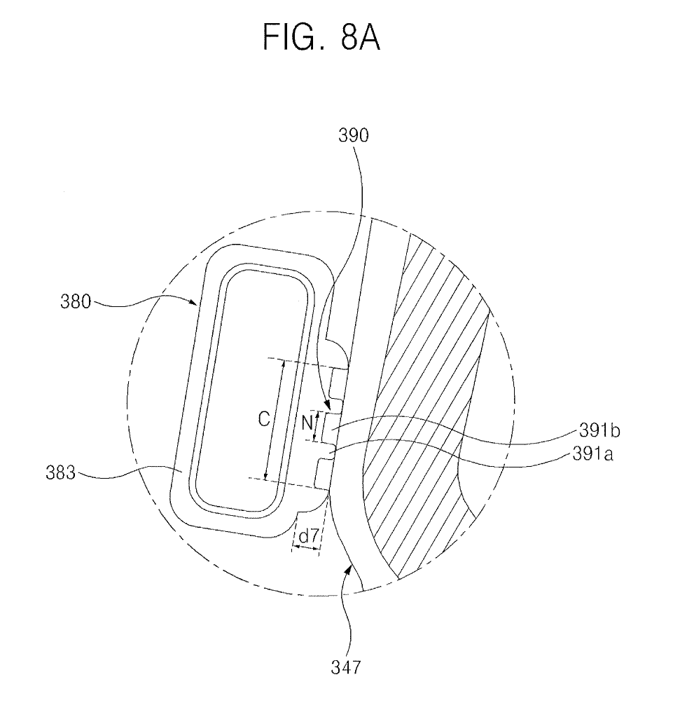

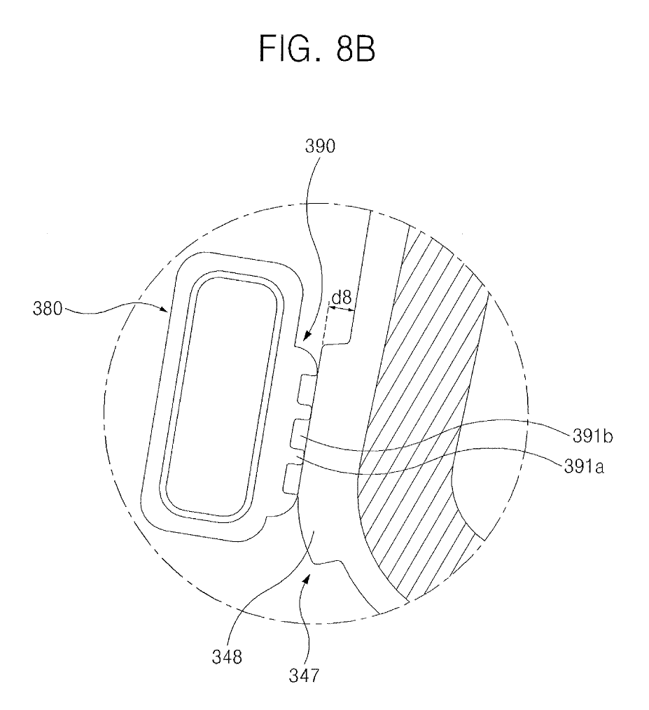

In the present specification and claims, when the contact area reduction portion is described as being “integral” with the bobbin, it is understood that the contact area reduction portion is formed in the same process as, and made of the same materials as, the adjacent portions of the bobbin. The contact area reduction portion that is integral with the bobbin (or the crash stop, as illustrated in FIG. 8A) is not formed in a separate process and later connected to the bobbin, as illustrated in FIG. 7.

An HDD according to another exemplary embodiment of the present inventive concept will be described with reference to the accompanying drawings. However, in the following description, the same descriptions on the constituent elements as those of the HDD according to the above first described exemplary embodiment will be omitted herein.

FIG. 8A is an enlarged plan view illustrating the contact area reduction portion provided in the crash stop of an HDD according to another exemplary embodiment of the present general inventive concept. Referring to FIG. 8A, a contact area reduction portion 390 of the present exemplary embodiment includes a plurality of crash stop protrusions 391a separated by concaves 391b inwardly formed on the surface of a buffer member 383 of a crash stop 380. Unlike the contact area reduction portion 190 of FIG. 3, the contact area reduction portion of FIG. 8A is located on the crash stop 380.

According to the above-described structure, while the function to absorb a shock during the collision between the crash stop 380 and a bobbin 347 is maintained, the stiction phenomenon of the crash stop 380 and the bobbin 347 is reduced during the burn-in process or high temperature reliability test of the HDD so that the generation of a defect due to the stiction phenomenon may be reduced.

FIG. 8B is similar to FIG. 8A, except the bobbin 347 includes an engaging protruding part 348 to engage the contact area reduction portion 390 of the crash stop. The protruding part 348 of the bobbin 347 may have a height d8.

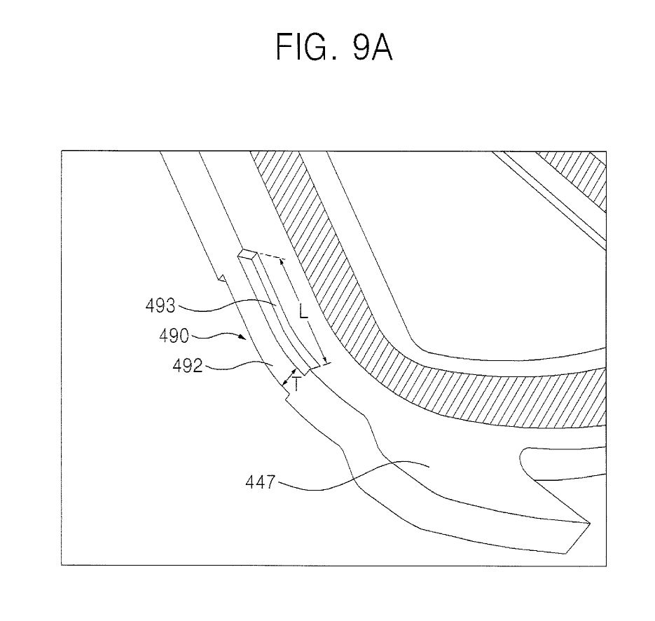

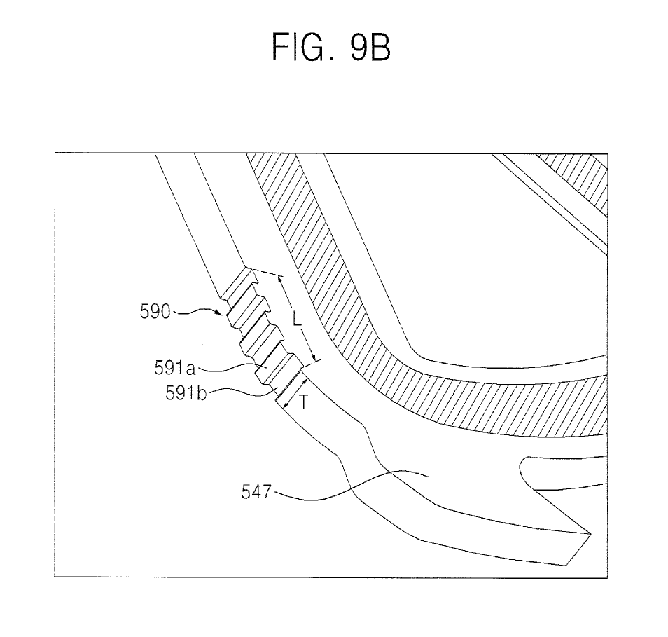

FIGS. 9A and 9B illustrate additional embodiments of a contact area reduction portion according to the present general inventive concept. FIG. 9A illustrates a bobbin 447 similar to the bobbin 147 of FIGS. 1-6C, except that the contact area reduction portion 490 includes recesses 493 that extend along edges of the bobbin 447 and a raised portion 492 having an outer surface that is co-planar with the outer surface of the side edge of the bobbin 447. In addition, the contact area reduction portion 490 does not include recesses extending between edges of the contact area reduction portion 490 to intersect the contact area reduction portion 490. In other words, if a thickness T of the contact area reduction portion 490 is defined as a distance between two sides of the raised portion 492 and a length L of the contact area reduction portion 490 is defined as a distance along the side edge of the bobbin 471, then the contact area reduction portion 490 of FIG. 9A does not include recesses along the thickness direction T of the contact area reduction portion 490.

On the other hand, FIG. 9B illustrates a bobbin 547 similar to the bobbin 147 of FIGS. 1-6C, except that the contact area reduction portion 590 of FIG. 9B has a thickness T that is the same as the thickness of the bobbin 547. In other words, the contact area reduction portion 590 has protrusions 591a separated by recesses 591b that extend in a thickness direction T of the bobbin 547 from one edge of the bobbin 547 to the other.

As described above, while the function to absorb a shock during the collision between the crash stop and the bobbin is maintained, the stiction phenomenon of the crash stop and the bobbin generated during the burn-in process or high temperature reliability test of the HDD is reduced. Thus, the generation of a defect may be reduced and yield and productivity may be improved.

While the present general inventive concept has been particularly shown and described with reference to exemplary embodiments thereof, it will be understood that various changes in form and details may be made therein without departing from the spirit and scope of the following claims.

Although a few embodiments of the present invention have been shown and described, it would be appreciated by those skilled in the art that changes may be made in these embodiments without departing from the principles and spirit of the general inventive concept, the scope of which is defined in the claims and their equivalents.

What is claimed is:

1. A hard disk drive comprising:
a head stack assembly including a read/write head mounted thereon and an actuator arm pivoting over a disk around a pivot shaft installed on a base, a pivot shaft holder rotatably supporting the pivot shaft and to which the actuator arm is coupled, and a bobbin located at an opposite side of the actuator arm with respect to the pivot shaft holder and having a voice coil motor coil located on at least one surface thereof;
a crash stop coupled to the base to restrict displacement of the actuator arm; and
a contact area reduction portion located on at least one of the bobbin and the crash stop and including at least one non-contact section in which the bobbin and the crash stop do not contact each other to reduce the contact area between the bobbin and the crash stop.

2. The hard disk drive of claim 1, wherein the contact area reduction portion comprises:
a plurality of concaves inwardly formed in one surface of the bobbin facing the crash stop.

3. The hard disk drive of claim 2, wherein an outer surface of each of a plurality of protrusions located between the plurality of concaves is located along substantially the same plane as an outer surface of the bobbin, and
each end of each outer surface of the plurality of protrusions is round-processed.

4. The hard disk drive of claim 1, wherein the contact area reduction portion comprises:
a plurality of concaves in a side surface of the bobbin facing the crash stop.

5. The hard disk drive of either claim 2, wherein the contact area reduction portion has a thickness thinner than that of the bobbin.

6. The hard disk drive of either claim 2, wherein the contact area reduction portion is integrally formed on the bobbin.

7. The hard disk drive of claim 1, wherein the crash stop comprises:
a housing shaft coupled to the base; and
a buffer member arranged outside the housing shaft and contacting the bobbin.

8. The hard disk drive of claim 7, wherein the contact area reduction portion comprises a plurality of concaves inwardly formed in a side surface of the buffer member facing the bobbin.

9. The hard disk drive of claim 7, wherein a buffer space to absorb a shock is located between the housing shaft and the buffer member.

10. The hard disk drive of claim 1, wherein the crash stop is an outer disk crash stop.

11. A hard disk drive, comprising:
a head stack assembly including a bobbin and an arm rotatable around a shaft; and
a crash stop to restrict movement of the bobbin,
wherein one of the bobbin and the crash stop includes a contact area reduction portion including a plurality of recesses to reduce a surface area of the bobbin that contacts the crash stop.

12. The hard disk drive according to claim 11, wherein the contact area reduction portion has a thickness less than a thickness of the bobbin.

13. The hard disk drive according to claim 11, wherein a depth of each of the plurality of recesses is less than a depth of the contact area reduction portion.

14. The hard disk drive according to claim 11, wherein the bobbin includes a first side, a second side opposite the first side, and a side edge connecting the first side to the second side,
the contact area reduction portion is located along the side edge, and
the plurality of recesses extend perpendicular to the first and second sides of the bobbin.

15. The hard disk drive according to claim 11, wherein the contact area reduction portion is located on the crash stop.

16. The hard disk drive according to claim 15, wherein the contact area reduction portion is formed separately from and mounted to the crash stop.

17. A head stack assembly, comprising:
an actuator arm including a shaft holder to mount to a shaft to rotate the actuator arm around the shaft;
a head at an end of the actuator arm to read data from and write data to a disk; and
a bobbin at an end of the actuator arm opposite the head to drive the actuator arm to rotate around the shaft,
wherein the bobbin includes a contact area reduction portion including a plurality of recesses to reduce a surface area of the bobbin that contacts a crash stop to restrict a rotation of the bobbin in a first rotation direction.

18. The head stack assembly according to claim 17, wherein the bobbin includes a voice coil motor coil to receive a magnetic force to drive the rotation of the actuator arm.

19. The head stack assembly according to claim 17, wherein the bobbin includes a hook to connect with a latch to prevent movement of the bobbin in a second rotation direction opposite the first rotation direction.
